(19) United States
(12) Patent Application Publication
(10) Pub. No.: US 2026/0358871 A1
(43) Pub. Date: Nov. 12, 2026

(54) VOLTAGE GUARD-BAND REDUCTION FOR PROCESSORS USING INSTRUCTION THROTTLING

(71) Applicant: International Business Machines Corporation, Armonk, NY (US)

(72) Inventors: Alejandro Alberto COOK LOBO, Renningen (DE); Ramon BERTRAN MONFORT, New York, NY (US); Alper BUYUKTOSUNOGLU, White Plains, NY (US); Ian Krispin CARMICHAEL, Round Rock, TX (US); Juan MEDINA, Rochester, MN (US); Phillip John RESTLE, Katonah, NY (US); Tobias WEBEL, Schwaebisch-Gmuend (DE)

(21) Appl. No.: 19/205,209

(22) Filed: May 12, 2025

(51) Int. Cl. G06F 1/30

(52) U.S. Cl. CPC G06F 1/305

(57) ABSTRACT

Calibration of a delay value for multiple digital droop sensors (DDSs) electrically connected to a plurality of cores in a processor. The multiple DDSs are each individually calibrated to help regulate fluctuations in voltage going to the processor by throttling the cores in the processor when the voltage droops below a user configurable threshold. Throttling the cores in the processor will halt execution of instructions and allow the voltage going to the processor to increase above the user configurable threshold.

### BACKGROUND

Processors may execute instructions to perform various operations. Voltage drops may occur in a processor when there are workload fluctuations for the processor or when there is noise from a power supply attached to the processor. When voltage drops occur, the processor's voltage can fall below a minimum voltage for the processor to function, causing the processor to execute instructions incorrectly.

### SUMMARY

Embodiments include a method, which includes calibrating delay values of a first digital droop sensor (DDS) and a second DDS electrically connected to a processor such that the first DDS throttles the processor at an input voltage and the second DDS throttles the processor at the input voltage. The method further includes determining a minimum voltage of the processor and a minimum delay value for the first and the second DDSs based on reducing (i) a voltage of the processor from the input voltage and (ii) the delay values of the first and the second DDSs from the calibrated delay values until the processor generates an error. The method further includes adding a user configurable amount to the minimum delay value to produce a guard-banded delay. The method further includes determining a voltage value for the voltage of the processor that causes the first and the second DDSs to throttle the processor below a first threshold at the guard-banded delay and storing a difference between the voltage value and the minimum voltage of the processor in a memory of a computer system as a voltage guard-band for the processor. The embodiments may also include a system.

Embodiments include a method, which includes determining different configurations for a first type of core of a processor and a second type of core of the processor, which includes calibrating delay values of DDSs electrically connected to the first and second types of cores such that the DDSs throttle the processor at an input voltage. The method further includes determining a first minimum voltage for the first type of core and a first minimum delay value for a first DDS of the DDSs based on reducing (i) a voltage of the first type of core from the input voltage and (ii) a delay value of the first DDS from the calibrated delay value of the first DDS until the first type of core generates a first error. The method further includes determining a second minimum voltage for the second type of core and a second minimum delay value for a second DDS of the DDSs based on reducing (i) a voltage of the second type of core from the input voltage and (ii) a delay value of the second DDS from the calibrated delay value of the second DDS until the second type of core generates a second error. The method further includes adding a first user configurable amount to the first minimum delay value to produce a first guard-banded delay. The method further includes adding a second user configurable amount to the second minimum delay value to produce a second guard-banded delay. The method further includes determining a first voltage value for the voltage of the first type of core that causes the first DDS to throttle the first type of core below a first threshold at the first guard-banded delay. The method further includes determining a second voltage value for the voltage of the second type of core that causes the second DDS to throttle the second type of core below the first threshold at the second guard-banded delay. The method further includes storing a first difference between the first voltage value and the first minimum voltage of the first type of core in a memory of a computer system as a first voltage guard-band for the first type of core and storing a second difference between the second voltage value and the second minimum voltage of the second type of core in the memory of the computer system as a second voltage guard-band for the second type of core.

### BRIEF DESCRIPTION OF THE DRAWINGS

FIG. 1A depicts a block diagram of a system including a processor and DDSs receiving a signal from a computer system, according to one embodiment.

FIG. 1B depicts a diagram of a DDS, according to one embodiment.

FIG. 1C depicts a diagram of a DDS throttling a processor, according to one embodiment.

FIG. 2 depicts a flowchart of an exemplary method for determining a voltage guard-band for a DDS, according to one embodiment.

FIG. 3 depicts a flowchart of an exemplary method for calibrating delay values of a DDS, according to one embodiment.

FIG. 4 depicts a diagram of an example operation for calibrating delay values, according to one embodiment.

FIG. 5 depicts a diagram of an example operation for determining a minimum voltage of a processor and a minimum delay for a DDS, according to one embodiment.

FIG. 6 depicts a diagram of an example operation for determining a voltage guard-band for a DDS, according to one embodiment.

FIG. 7 is a block diagram of an example computer environment for use in conjunction with one or more embodiments of architecture for determining the voltage guard-band for one of the DDSs, according to one embodiment.

### DETAILED DESCRIPTION

The present disclosure describes a system and method for determining a voltage guard-band for a processor with an electronically connected DDS. The processor receives a voltage from a power supply, so that the processor may complete instructions that it receives from a computer system. As the number of instructions that the processor is receiving and executing fluctuates or as the processor receives noise from a power supply, the voltage of the processor may drop (or droop). This voltage drop can cause errors in the processor or stop the processor entirely if the voltage drops below a threshold. A manufacturer for the processor could set a static voltage guard-band for the processor, which will help prevent the voltage of the processor from dropping (or drooping) below the threshold. However, by assigning a static voltage guard-band, the voltage guard-band may be larger than sufficient to protect the processor because the processor may implement other features (e.g., instruction throttling using one or more digital droop sensors (DDSs)) that help protect the voltage from dropping below the threshold.

The DDSs may detect when the voltage drops below the respective voltage guard-band. When a DDS detects that the voltage dropped, the DDS may trigger a throttling control to throttle the processor. By throttling the processor, the processor may stop executing instructions, which allows the processor to cooldown and the voltage of the processor to increase. When the voltage of the processor returns to a voltage around the voltage before the droop, the throttling control may stop throttling the processor, so the processor can continue executing instructions.

The present disclosure describes a process of determining a voltage guard-band for processors that implement instruction throttling using a DDS. To determine the voltage guard-band a computer system (i) determines a delay value where the processor throttles at or below a first threshold while keeping the voltage to the DDS constant; (ii) determines a minimum voltage and a minimum delay value by decrementing the voltage and the delay value until an error occurs in the processor; (iii) determines the voltage corresponding to the minimum delay value plus a configurable delay value; and (iv) determines the difference between the voltage and the minimum voltage.

In certain embodiments, the process for determining the voltage guard-band provides several technical advantages. For example, the voltage guard-band may be added to the voltage of the processor along with throttling the processor by the DDS to keep the processor voltage from dropping so far that the processor generates an error. Because the voltage guard-band is determined by considering the throttling provided by the DDS, the voltage guard-band may be lower than the voltage guard-band set for existing systems.

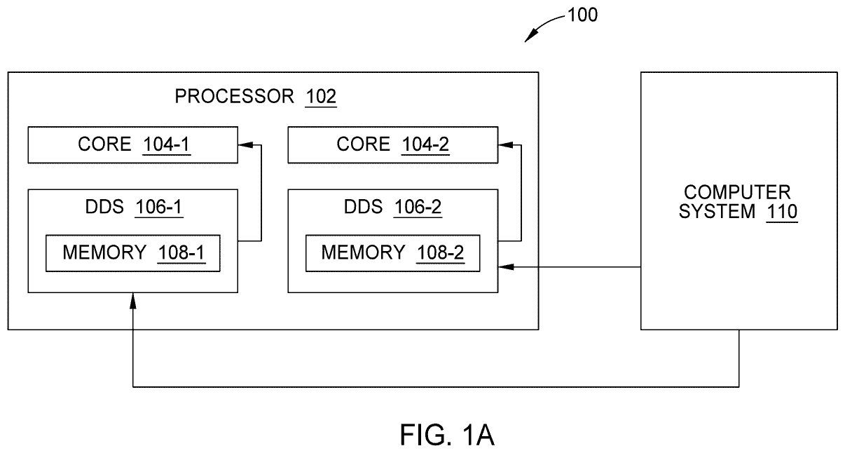

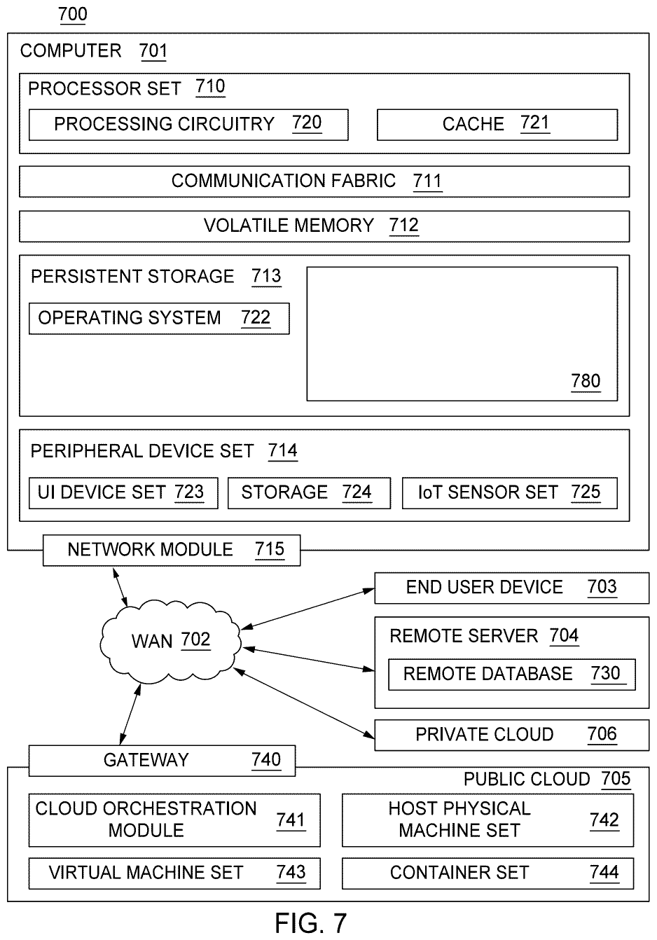

FIG. 1A depicts a block diagram of a system 100 for determining a voltage guard-band for a processor 102. In some embodiments, the system 100 includes the processor 102 electrically connected to a computer system 110 (which may be the computer system 700 shown in FIG. 7). The processor 102 has one or more cores and one or more DDSs. In the example of FIG. 1A, the processor 102 includes cores 104-1 and 104-2 and DDSs 106-1 and 106-2. Each of the cores 104-1 and 104-2 are electrically connected to the DDSs 106-1 and 106-2, respectively. In some instances, the cores 104-1 and 104-2 are each electrically connected multiple DDSs. Each DDS 106 may be connected to a memory 108 that stores values related to the DDS 106. In the example of FIG. 1A, the DDS 106-1 is connected to the memory 108-1, and the DDS 106-2 is connected to the memory 108-2. The computer system 110 may have a memory to store information related to the voltage guard-band for the processor.

FIG. 1B depicts a diagram of a DDS 106 (e.g., the DDSs 106-1 or 106-2 in FIG. 1A). As seen in FIG. 1B, the DDS 106 includes a pulse generator 112, a delay circuit 114, and a latch circuit 116. Generally, the DDS 106 detects when the voltage in a processor drops, and the DDS 106 may trigger instruction throttling at the processor to mitigate the voltage drop.

The DDS 106 receives a voltage (e.g., an operating voltage or chip voltage) from a processor (e.g., the processor 102 in FIG. 1A). The DDS 106 generates a pulse using the pulse generator 112 and directs the pulse through the delay circuit 114. The voltage received by the DDS 106 determines the speed at which the pulse travels through the delay circuit 114. The delay circuit 114 delays or slows down the pulse by a user configurable amount of delay and directs the delayed pulse to the latch circuit 116.

The latch circuit 116 includes a number of latches (which may also be referred to as bins). In the example of FIG. 1B, the latch circuit 116 includes twenty-three bins. Depending on the speed of the delayed pulse from the delay circuit 114, the delayed pulse may travel through a certain number of bins of the latch circuit 116 (which may also be referred to as a bin value) in a set amount of time. For example, a fast pulse may reach 19 to 23 bins, while a slow pulse may reach 0 to 4 bins. Thus, the bin value for a pulse may indicate the voltage that the DDS 106 received from the processor.

FIG. 1C depicts a diagram of a DDS 106 (e.g., the DDS 106-1 or the DDS 106-2 in FIG. 1A) throttling a processor (e.g., the processor 102 in FIG. 1A). The DDS 106 receives a voltage (e.g., an operating voltage or chip voltage) from the processor along with a delay value for the delay circuit of the DDS 106. As explained above, the DDS 106 uses the voltage and the delay value to determine a bin value. The DDS 106 directs the bin value to a throttling control, which compares the bin value with a threshold (which may also be referred to as a threshold bin). If the bin value exceeds the threshold, then instructions to the processor may not be throttled. If the bin value falls below the threshold, then the voltage from the processor may have dropped too much and instructions to the processor may be throttled. By throttling the instructions to the processor, the number of instructions that are directed to the processor in a set time is reduced. As a result, the operating speed of the processor is slowed down or limited, which may mitigate the voltage drop.

Generally, the threshold may indicate the point when a core (e.g., the cores 104-1 or 104-2 in FIG. 1A) should be throttled. For example, if the threshold is ten bins and the pulse reached nineteen bins, then the core should be throttled less or not at all. In comparison, if the threshold is ten bins and the pulse reached three bins, then the core should be throttled.

Returning to FIG. 1A, the computer system 110 performs a process that sets one or more voltage guard-bands used by the DDSs 106 of the processor 102. To determine a voltage guard-band, the computer system 110 (i) determines a delay value where the processor throttles at or below a first threshold when the voltage to the DDS 106 remains constant; (ii) determines a minimum voltage and a minimum delay value by decrementing the voltage and the delay value until an error occurs in the processor 102; and (iii) determines a voltage guard-band by increasing the minimum delay value by a configurable value to a guard-banded delay and increasing the voltage until the processor 102 is throttling the same amount as when the processor 102 was at the minimum voltage while maintaining the guard-banded delay value. The voltage guard-band may be set as the difference between the maximum voltage and the minimum voltage.

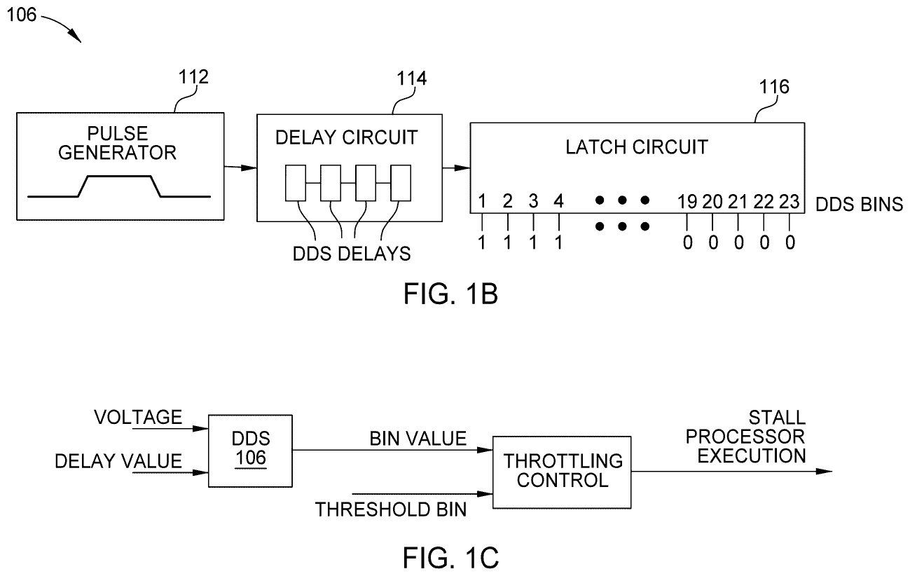

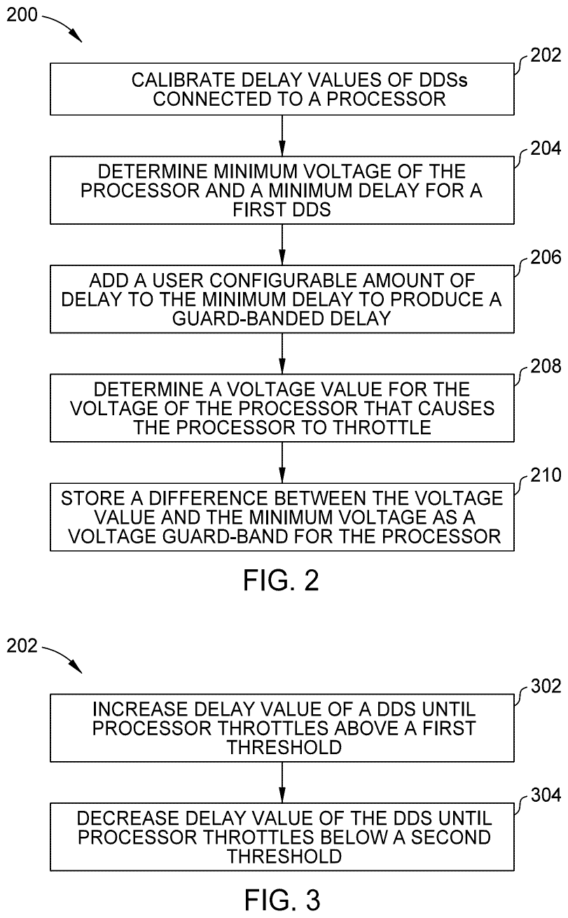

FIG. 2 depicts a flowchart of an exemplary method 200 for determining a voltage guard-band used by a DDS (e.g., the DDS 106-1 or 106-2 in FIG. 1A). At block 202, a computing system (e.g., the computing system 110 in FIG. 1A) calibrates delay values for each DDS that is electrically connected to a processor (e.g., the processor 102 in FIG. 1A). The computing system calibrates the delay values for the DDSs by finding a delay value for each DDS such that each DDS causes the processor to be throttled at the same voltage. The block 202 is further described in FIG. 3.

At block 204, the computing system determines a minimum voltage of the processor and a minimum delay value for the DDSs. To find the minimum voltage, the computer system decreases a voltage of the processor and a delay of the DDSs until an error occurs in the processor. In some embodiments, the computer system starts at (i) the voltage value used for calibrating the delay value for the DDSs and (ii) the calibrated delay values. The computer system may decrease the voltage of the processor proportionally to the delay of the DDSs. The computer system may set the minimum delay for the DDSs to the delay when the error occurs plus one, and the computer system may set the minimum voltage to a respective voltage to prevent the processor's voltage from getting low enough for the error to occur. In some embodiments, the computer system stores the minimum delay in the memory of the DDS. In some embodiments, the minimum voltage is stored in memory on the computer system.

At block 206, the computing system adds a user configurable amount of delay to the minimum delay to produce a guard-banded delay. A large user configurable amount of delay results in a larger voltage guard-band and a smaller user configurable amount of delay results in a smaller voltage guard-band.

At block 208, to set a voltage guard-band, the computing system determines a resulting voltage value for the voltage of the processor that causes the processor to throttle between zero and a small positive throttling threshold at the guard-banded delay. In some embodiments, the computer system increases the voltage value from the minimum voltage value while holding the delay at the guard-banded delay until the processor throttles below a small non-zero throttling threshold.

At block 210, the computing system stores a difference between the resulting voltage value and the minimum voltage as a voltage guard-band for the DDS. The voltage guard band may be added to the minimum operating voltage or chip voltage of the processor, which may help reduce the probability of an error in the processor in the field. Additionally, the computer system may determine a voltage guard band for the processor that is smaller than the static voltage guard band that existing systems would set for the processor.

FIG. 3 depicts a flowchart of the block 202 in FIG. 2 for calibrating delay values of a DDS. At block 302, a computer system (e.g., the computer system 110 in FIG. 1A) calibrates the DDS (e.g., the DDS 106-1 or 106-2 in FIG. 1A) by increasing a delay value of the DDS until an electrically attached processor (e.g., the processor 102 in FIG. 1A) throttles beyond a first threshold. For example, the computer system may incrementally increase the delay value until the processor throttles at (or above) the first threshold. While increasing the delay value, the computer system may maintain a constant voltage value to the DDS. When calibrating other DDSs, the computer system may also maintain the same constant voltage value at the other DDSs.

At block 304, the computer system decreases the delay value for the DDS until the processor throttles at (or below) a second threshold. In some embodiments, the computer system decrements the delay value until the processor throttles at or below the second threshold. The computer system may maintain the same constant voltage to the DDS while reducing the delay value. The resulting delay value is the calibrated delay value for the DDS. The computer system may follow the same method for other DDSs, but determine that the other DDSs have different calibrated delay values.

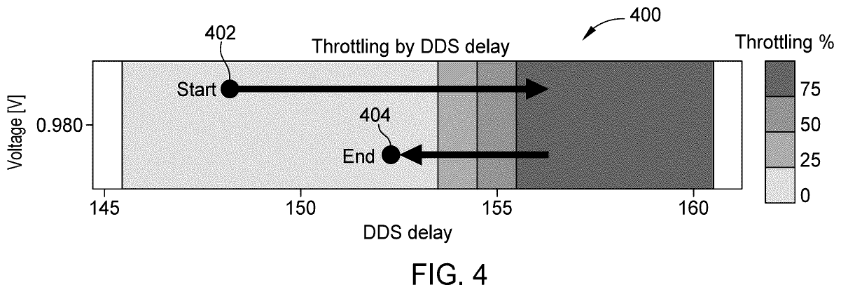

FIG. 4 depicts a diagram of an example operation 400 for calibrating delay values for a DDS (e.g., the DDS 106-1 or 106-2 in FIG. 1A) as described in FIG. 3. A computer system (e.g., the computer system 110 in FIG. 1A) determines the delay values for the DDS by increasing/decreasing the delay until a processor (e.g., the processor 102 in FIG. 1A) throttles according to various thresholds. As seen in FIG. 3, the computer system maintains a constant voltage value (e.g., 0.980 V), starts the delay value at a starting delay value 402, and increases the delay values until the processor throttles above a first threshold (e.g., 3%, 75%, etc.). The computer system then decreases the delay value until the processor throttles at or below a second threshold (e.g., 0.5%). The resulting delay value is a calibrated delay value 404.

In the example of FIG. 4, the computer system may maintain a constant voltage of 0.980 V and start with a delay value 402 of 148. The computer system then incrementally increases the delay value 402 up to a delay value of 157, when the processor throttles beyond a first threshold (e.g., 75%). The computer system then decreases the delay value down to a delay value of 152, when the processor throttles below a second threshold (e.g., 0.5%). The delay value of 152 is then considered the calibrated delay value 404 for the DDS.

There may be multiple methods to determine the calibrated delay value 404 for a DDS. In some embodiments, when calibrating the DDS, the computer system increments/decrements the delay value by a constant number to determine the calibrated delay value 404. Additionally, or alternatively, when calibrating the DDS, the computer system determines the calibrated delay value 404 by determining a low delay value, a high delay value, and a middle delay value between the low and the high delay values. The computer system compares the throttling at the middle delay value with the second threshold to determine if the middle delay value is too high or too low. If the middle delay value is too high, the computer system determines a new middle value between the middle delay value and the low delay value and repeats the check until the computer system finds the calibrated delay value 404. If the middle delay value is too low, then the computer system finds the new middle delay value between the middle delay value and the high delay value and repeats the check until the computer system determines the calibrated delay value 404. In some embodiments, the calibrated delay value 404 and the constant voltage value are stored in a memory (e.g., the memory 108-1 or 108-2) of the DDS.

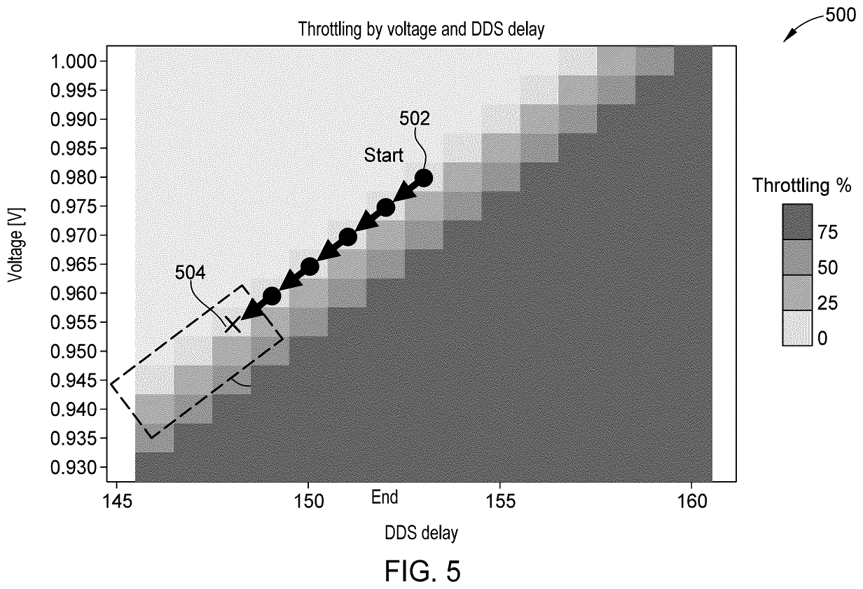

FIG. 5 depicts a diagram of an example operation 500 for determining a minimum voltage of a processor (e.g., the processor 102 in FIG. 1A) and a minimum delay for the DDSs (e.g., the DDS 106-1 or 106-2 in FIG. 1A). As described in FIG. 2, a computer system (e.g., the computer system 110 in FIG. 1A) proportionally decrements a voltage of the processor and a delay of the DDSs until an error occurs in the processor. In some embodiments, the computer system retrieves starting values 502 from the memory (e.g., the memory 108-1 or 108-2 in FIG. 1A) of the DDSs that were stored during calibration. The starting values may be the calibrated delay value for the DDSs and the constant voltage value used during calibration. In the example of FIG. 5, the computer system uses the starting voltage value of 0.980 V for the processor and the calibrated delay value of 152 for one of the DDSs (the calibrated values found in FIG. 4). The computer system proportionally decrements the voltage value and the delay value to maintain a throttling percentage of 0.5% until an error occurs in the processor at a voltage value of 0.955 V and a delay value of 148. The computer system then determines minimum values 504 for the voltage value being 0.955 V and the delay value being 148, which are the minimum voltage of the processor and the minimum delay for the DDS, respectively.

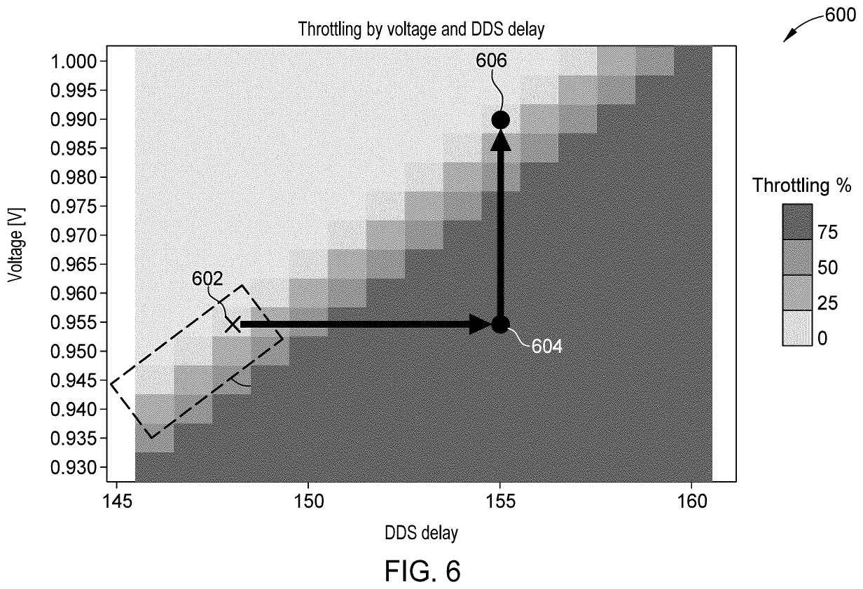

FIG. 6 depicts a diagram of an example operation 600 for determining a second voltage value for setting a voltage guard-band for a processor (e.g., the processor 102 in FIG. 1A). In some embodiments, a computer system (e.g., the computer system 110 in FIG. 1A) determines and sets a minimum delay value of the DDSs and a minimum voltage value for the processor as a starting point 602. In the example of FIG. 6, the computer system determines and sets the processor to the minimum voltage value of 0.955 V and the DDS to the minimum delay value of 148 (the values found in FIG. 4).

To set a voltage guard-band, the computer system determines a second voltage value and a second delay value where the processor is throttling between zero and a small positive throttling threshold. In some embodiments, the second delay value is determined by increasing the minimum delay value by a user configurable amount of delay to produce a guard-banded delay for the processor. In the example of FIG. 6, the minimum delay value of 148 is increased by seven to 155 at point 604 while the voltage value remains at 0.955 V.

The second voltage value may then be determined by increasing the voltage value from the minimum voltage value to a voltage value where the processor is throttling between zero and a small positive throttling threshold while maintaining the guard-banded delay value. In the example of FIG. 6, the computer system incrementally increases the voltage value from 0.955 V to 0.990 V at point 606, where the processor is throttling at the same amount as the processor throttles at the starting point 602 while maintaining the delay value of 155. The computer system then determines the voltage guard-band as the difference between the minimum voltage value and the voltage at the point 606. In some embodiments, the voltage guard-band can be expressed in terms of delay values based on the minimum delay value and the delay value at the point 604. The computer system may then store the voltage guard-band in memory on the computer system.

During operation, the voltage guard-band may be added to the voltage from the processor. This increase in the voltage from the processor coupled with the throttling provided by the DDS may be sufficient to reduce the probability of an error in the processor in the field. In some embodiments, because the voltage guard-band is determined by considering the throttling provided by the DDS, the voltage guard-band may be lower than the voltage guard-band set for existing systems for the processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as determining a voltage guard-band for a DDS electrically connected to a processor in block 780. In addition to block 780, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 780, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 780 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 780 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

While the foregoing is directed to embodiments of the present invention, other and further embodiments of the invention may be devised without departing from the basic scope thereof, and the scope thereof is determined by the claims that follow.

What is claimed is:

1. A method comprising:
calibrating delay values of a first digital droop sensor (DDS) and a second DDS electrically connected to a processor such that the first DDS throttles the processor at an input voltage and such that the second DDS throttles the processor at the input voltage;
determining a minimum voltage of the processor and a minimum delay value for the first and the second DDSs based on reducing (i) a voltage of the processor from the input voltage and (ii) the delay values of the first and the second DDSs from the calibrated delay values until the processor generates an error;
adding a user configurable amount to the minimum delay value to produce a guard-banded delay;
determining a voltage value for the voltage of the processor that causes the first and the second DDSs to throttle the processor below a first threshold at the guard-banded delay; and
storing a difference between the voltage value and the minimum voltage of the processor in a memory of a computer system as a voltage guard-band for the processor.

2. The method of claim 1, wherein calibrating the delay values of the first DDS comprises:
increasing the delay value of the first DDS until the first DDS throttles the processor above a second threshold at the input voltage; and
decreasing the delay value of the first DDS until the first DDS throttles the processor below the first threshold.

3. The method of claim 2, wherein decreasing the delay value occurs after increasing the delay value.

4. The method of claim 1, wherein determining the minimum voltage of the processor and the minimum delay value for the first and the second DDSs comprises reducing the voltage of the processor from the input voltage and the calibrated delay value of the first and the second DDSs proportionally with respect to each other.

5. The method of claim 1, wherein determining the minimum voltage of the processor and the minimum delay value for the first and the second DDSs comprises adjusting the voltage of the processor until the first and the second DDSs throttle the processor below the first threshold and above a second threshold.

6. The method of claim 1, wherein determining the minimum voltage of the processor and the minimum delay value for the first and the second DDSs comprises executing a set of instructions by the processor at the minimum voltage and with the DDSs set at their minimum delay value to generate the error.

7. The method of claim 1, wherein the voltage value causes every core of the processor to throttle below the first threshold.

8. A test system comprising:
a processor set;
one or more computer-readable storage media; and
program instructions stored on the one or more computer-readable storage media to cause the processor set to perform operations comprising:
calibrating delay values of a first digital droop sensor (DDS) and a second DDS electrically connected to a processor in the processor set such that the first DDS throttles the processor at an input voltage and such that the second DDS throttles the processor at the input voltage;
determining a minimum voltage of the processor and a minimum delay value for the first and the second DDS based on reducing (i) a voltage of the processor from the input voltage and (ii) the delay values of the first and the second DDSs from the calibrated delay values until the processor generates an error;
adding a user configurable amount to the minimum delay value to produce a guard-banded delay;
determining a voltage value for the voltage of the processor that causes the first and the second DDSs to throttle the processor below a first threshold at the guard-banded delay; and
storing a difference between the voltage value and the minimum voltage of the processor in a memory of a computer system as a voltage guard-band for the processor.

9. The test system of claim 8, wherein calibrating the delay values of the first DDS comprises:
increasing the delay value of the first DDS until the first DDS throttles the processor above a second threshold at the input voltage; and
decreasing the delay value of the first DDS until the first DDS throttles the processor below the first threshold.

10. The test system of claim 9, wherein decreasing the delay value occurs after increasing the delay value.

11. The test system of claim 8, wherein determining the minimum voltage of the processor and the minimum delay value for the first and the second DDSs comprises reducing the voltage of the processor from the input voltage and the calibrated delay value of the first and the second DDSs proportionally with respect to each other.

12. The test system of claim 8, wherein determining the minimum voltage of the processor and the minimum delay value for the first and the second DDSs comprises adjusting the voltage of the processor until the first DDS throttles the processor below the first threshold and above a second threshold.

13. The test system of claim 8, wherein determining the minimum voltage of the processor and the minimum delay value for the first and the second DDSs comprises executing a set of instructions by the processor at the minimum voltage and with the first and the second DDSs set at the minimum delay value to generate the error.

14. The test system of claim 8, wherein the voltage value causes every core of the processor to throttle below the first threshold.

15. A method comprising:
determining different configurations for a first type of core of a processor and a second type of core of the processor by:
calibrating delay values of digital droop sensors (DDSs) electrically connected to the first and second types of cores such that the DDSs throttle the processor at an input voltage;
determining a first minimum voltage for the first type of core and a first minimum delay value for a first DDS of the DDSs based on reducing (i) a voltage of the first type of core from the input voltage and (ii) a delay value of the first DDS from the calibrated delay value of the first DDS until the first type of core generates a first error;
determining a second minimum voltage for the second type of core and a second minimum delay value for a second DDS of the DDSs based on reducing (i) a voltage of the second type of core from the input voltage and (ii) a delay value of the second DDS from the calibrated delay value of the second DDS until the second type of core generates a second error;
adding a first user configurable amount to the first minimum delay value to produce a first guard-banded delay;
adding a second user configurable amount to the second minimum delay value to produce a second guard-banded delay;
determining a first voltage value for the voltage of the first type of core that causes the first DDS to throttle the first type of core below a first threshold at the first guard-banded delay;
determining a second voltage value for the voltage of the second type of core that causes the second DDS to throttle the second type of core below the first threshold at the second guard-banded delay;
storing a first difference between the first voltage value and the first minimum voltage of the first type of core in a memory of a computer system as a first voltage guard-band for the first type of core; and
storing a second difference between the second voltage value and the second minimum voltage of the second type of core in the memory of the computer system as a second voltage guard-band for the second type of core.

16. The method of claim 15, wherein calibrating the delay values of the first DDS comprises:
increasing the first delay value of the first DDS until the first DDS throttles the first type of core above a second threshold at the input voltage; and
decreasing the first delay value of the first DDS until the first DDS throttles the first type of core below the first threshold.

17. The method of claim 16, wherein decreasing the first delay value occurs after increasing the first delay value.

18. The method of claim 15, wherein determining the first minimum voltage of the first type of core and the first minimum delay value for the first DDS comprises reducing the voltage of the first type of core from the input voltage and the calibrated delay value of the first DDS proportionally with respect to each other.

19. The method of claim 15, wherein determining the first minimum voltage of the first type of core and the first minimum delay value for the first DDS comprises adjusting the voltage of the first type of core until the first DDS throttles the first type of core below the first threshold and above a second threshold.

20. The method of claim 15, wherein determining the first minimum voltage of the first type of core and the first minimum delay value for the first DDS comprises executing a set of instructions by the first type of core at the first minimum voltage and with the first DDS set at the first minimum delay value to generate the first error.
